(19) United States
(12) Patent Application Publication
(10) Pub. No.: US 2015/0119034 A1
(43) Pub. Date: Apr. 30, 2015

(54) METHOD AND SYSTEM FOR MANAGING WIRELESS ACCESS TO A COMMUNICATION SYSTEM

(71) Applicant: AT&T Mobility II, LLC, Atlanta, GA (US)

(72) Inventors: Yunpeng Li, Austin, TX (US); Jerry Jun, Austin, TX (US)

(73) Assignee: AT&T Mobility II, LLC, Atlanta, GA (US)

(21) Appl. No.: 14/068,846

(22) Filed: Oct. 31, 2013

(51) Int. Cl. H04W 36/00; H04W 60/00; H04W 88/06

(52) U.S. Cl. CPC H04W 36/0022; H04W 88/06; H04W 60/00
USPC 455/435.2; 455/552.1

(57) ABSTRACT

A method that incorporates the subject disclosure may include, for example, setting a timer to a time period according to sensing of a fallback event, where routing of network communication to a service provider network is switched from a first radio access technology to a second radio access technology, detecting an expiration of the time period at timer, enabling registration according to the detecting both the expiration of the time period and detecting a data service access request at a user interface, and sending a registration request to rejoin the first radio access technology according to the enabling of registration. Other embodiments are disclosed.

### FIELD OF THE DISCLOSURE

The subject disclosure relates to a method and system for managing wireless access to a communication system.

### BACKGROUND

Communication systems, such as a mobile communications system, can be used for providing various services, including voice, video and/or data services, and user location information can be important for next generation IP multi-media services provided by telecommunication systems As the number of users and their service requirements increase, the load on the network increases. Infrastructure expansion and improvement can lessen the network load but is costly.

### BRIEF DESCRIPTION OF THE DRAWINGS

Reference will now be made to the accompanying drawings, which are not necessarily drawn to scale, and wherein:

FIG. 1 depicts an illustrative embodiment of a cellular system for providing network access to a mobile device via alternative radio access technologies;

FIG. 2 depicts an illustrative embodiment of a method for reliably switching between a first radio access technology and a second radio access technology;

FIG. 3 depicts an illustrative embodiment of the cellular system for providing network access to a mobile device via alternative radio access technologies;

FIG. 4 depicts an illustrative embodiment of a communication device that can be used in achieving network access via alternative radio access technologies; and

FIG. 5 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments of a method and system for providing network access to a mobile device via alternative radio access technologies. The exemplary embodiments manage fallback and return transitions for User Equipment (UE), or mobile communication devices operating at a Long Term Evolution (LTE) network. The mobile communication devices can wirelessly communicate with the LTE network using an LTE Radio Access Technology (RAT), such as Evolved Universal Terrestrial Radio Access Network (E-UTRAN). The mobile communications device can also communicate with the LTE network using one or more secondary RATs, such as Universal Mobile Telecommunications System (UMTS), Global System for Communications (GSM), Evolution Data Only (EVDO), Code Division Multiple Access (CDMA), and the like.

During an event, such as an excess loading of the LTE RAT, the system can force mobile communication devices to fallback from the primary LTE RAT to a secondary RAT. Whereas the primary LTE RAT can transmit data and voice using only packet-switched services, the secondary LTE RAT can transmit data and voice using circuit-switched technology. As a result, during fallback mode, user experience can be diminished, especially with respect to high speed data services. Ideally, each mobile communication device can return to the LTE RAT as soon as the loading event is alleviated. In practice, the ending of a fallback inducing event can cause a large number of mobile communication devices to attempt to return to the LTE RAT at essentially the same time. Mass attempts to re-register a large number of devices at the same time can burn excessive network resources at the Evolved Node B (eNodeB), the Mobility Management Entity (MME), and the Home Subscriber Server (HSS) as registration requests are processed. Further, en mass re-registrations can cause an immediate re-overloading of the LTE RAT or repeated denials of registration access, which can result in further fallback transitions (ping-ponging) or delays in clearing bottlenecks. The exemplary embodiments described herein can limit fallback-return transition problems by causing mobile communication devices to attempt to re-register at random times after the LTE RAT becomes available.

One embodiment of the subject disclosure is a mobile communication device that includes a memory to store executable instructions and a processor coupled to the memory, where the processor, responsive to executing the executable instructions, performs operations comprising sensing a fallback event, where routing of network communication to a service provider network is switched from a first radio access technology to a second radio access technology. The processor can perform operations for setting a timer to a variable time period according to the sensing of the fallback event and, in turn, detecting an expiration of the variable time period at timer. The processor can further perform operation for detecting an input at a user interface responsive to the detecting of the expiration of the variable time period and determining whether the input comprises a data service access request. The processor can perform operations for sending a registration request to rejoin the first radio access technology responsive to the detecting of the data service access request and, in turn, sensing a return event according to the registration request, wherein the routing of the network communication to the service provider network is switched from the second radio access technology to the first radio access technology.

One embodiment of the subject disclosure includes a computer-readable storage device, comprising executable instructions that, responsive to being executed by a processor, cause the processor to perform operations comprising sensing a fallback event, where routing of network communication to a service provider network is switched from a first radio access technology to a second radio access technology. The processor can also perform operations comprising setting a timer to a time period according to the sensing of the fallback event and, in turn, detecting an expiration of the time period at timer. The processor can further perform operations comprising detecting a data service access request at a user interface. The processor can perform operations comprising enabling registration according to detecting both the expiration of the time period and the data service access request and, in turn, sending a registration request to rejoin the first radio access technology according to the enabling of the registration. The processor can also perform operations comprising sensing a return event according to the registration request, wherein the routing of the network communication to the service provider network is switched from the second radio access technology to the first radio access technology.

One embodiment of the subject disclosure includes a method, including setting, at a system comprising a processor, a timer to a time period according to sensing of a fallback event, wherein routing of network communication to a service provider network is switched from a first radio access technology to a second radio access technology. The method further includes detecting, by the system, an expiration of the time period at timer and, in turn, enabling, by the system, registration according to the detecting both the expiration of the time period and detecting a data service access request at a user interface. The method also includes sending, by the system, a registration request to rejoin the first radio access technology according to the enabling of registration.

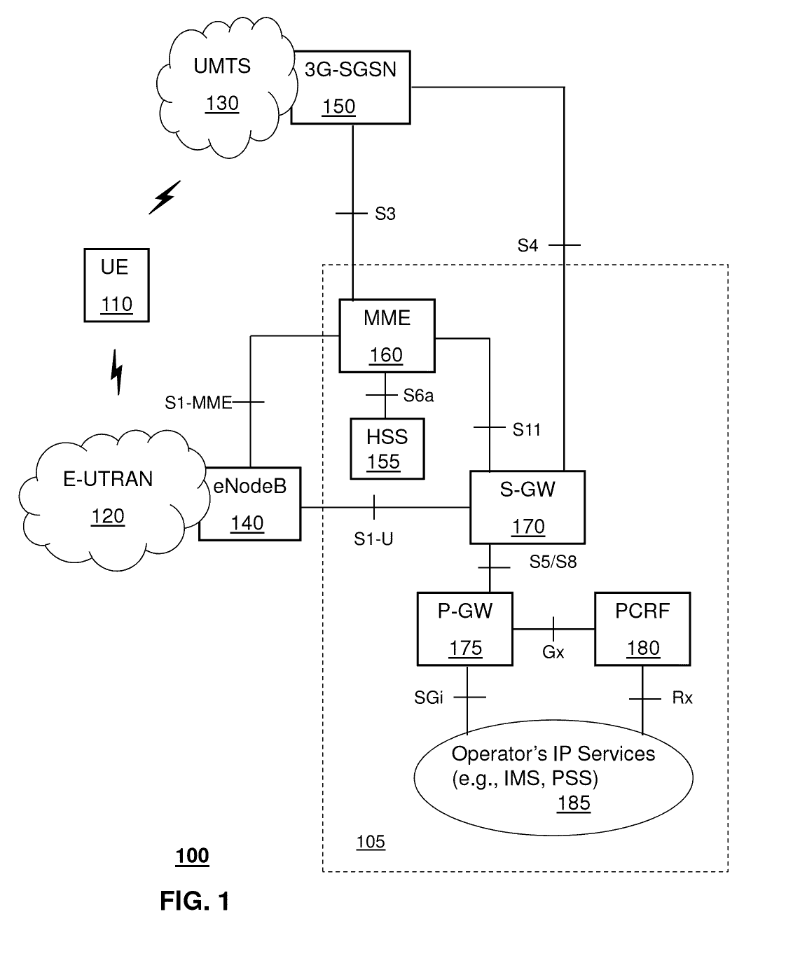

FIG. 1 depicts an illustrative embodiment of a system 100 that can limit fallback-return transition problems by causing mobile communication devices to attempt to re-register at random times after an LTE RAT becomes available. By randomizing registration times, the system 100 can improve overall system performance and user satisfaction by allowing mobile devices return to full LTE performance quickly, without ping-ponging between packet-switched and circuit-switched access. Also, system 100 can configure return delays to account for network conditions and to account for differences in subscriber service levels.

In FIG. 1, a mobile communication system 100 is illustrated that can provide communication services, including voice, video and/or data services to mobile devices, such as mobile communication device, or end user device 110. System 100 can enable communication services over a number of different networks, such as between end user device 110 and another communication device (e.g., a second end user device) not shown. End user device 110 can be a number of different types of devices that are capable of voice, video and/or data communications, including a mobile device (e.g., a smartphone), a personal computer, a set top box, and so forth.

System 100 can include an end user device 110, a primary Long-Term Evolution (LTE) Radio Access Technology (RAT) network 120, such as E-UTRAN, a secondary RAT network 185, such as a Universal Mobile Telecommunications System (UMTS), a Global System for Communications (GSM) network, Evolution Data Only (EVDO) network, or a Code Division Multiple Access (CDMA) network. The system 100 can further include one or more of a Third-Generation Serving General packet radio service Support Node (3G-SGSN) 150, and a Mobility Management Entity (MME) 160. Other components not shown can also be utilized for providing communication services to the UE 110, such as a Mobile Switching Center (MSC) which can facilitate routing voice calls and Short-Message Service (SMS), as well as other services (e.g., conference calls, FAX and circuit switched data) via setting up and releasing end-to-end connections, handling mobility and hand-over requirements during the communications, and/or performing charging and real time pre-paid account monitoring.

In one or more embodiments, system 100 can provide for circuit switching as a fallback for packet switching so as to enable the provisioning of voice and other circuit switching-domain services (e.g., circuit switching UDI video/LCS/USSD) by reuse of circuit switching infrastructure, whenever the packet switching-domain services are down or overloaded. For example, an end-user device 110 can be served by E-UTRAN 120 connecting to Evolved Node B 140 for accessing packet-switched services. At some point, E-UTRAN 120 can become unavailable or can experience impaired availability due overloading and/or required maintenance. In response to the unavailability, E-UTRAN 120 can disconnect from the end-user device 110. As a fallback response, the end-user device 110 can respond by establishing a connection with UMTS 130 or can activate a prior connection with UMTS 130. The end-user device 110 can access the core functions 105 of the service provider network via UMTS 130 and 3G-SGSN 150. In one or more embodiments, a circuit-switching fallback enabled terminal (e.g., UE 110) connected to E-UTRAN 140 may use UMTS 130 to connect to the circuit switching-domain in fallback mode. In one or more embodiments, the circuit switching fallback and the Internet Protocol Multimedia Subsystem (IMS) based services of system 100 can co-exist in a single service operator's network 185.

In one or more embodiments, in primary mode (i.e., not fallback) E-UTRAN 120 can include one or more eNodeB 140 and radio network controllers which enable carrying many traffic types including real-time circuit-switched to IP-based packet switched traffic. In one or more embodiments, E-UTRAN 120 can also enable connectivity between the end user device 110 and the core network 105. E-UTRAN 120 can utilize a number of interfaces including Iu, Uu, Iub and/or Iur. In one or more embodiments, UNTS 130 can facilitate communications between base stations (e.g., Ater and Abis interfaces) and base station controllers (e.g., A interfaces).

In one or more embodiments, E-UTRAN 120 can be the air interface for an LTE upgrade path for mobile networks according to the 3GPP specification. E-UTRAN 140 can include one or more eNodeB nodes on the network that are connected to each other such as via X2 interfaces and which are further connectable to the packet-switch core network 105 via an S1 interface. For example, E-UTRAN 120 can use various communication techniques including orthogonal frequency-division multiplexing (OFDM), multiple-input multiple-output (MIMO) antenna technology depending on the capabilities of the terminal, and beam forming for downlink to support more users, higher data rates and lower processing power required on each handset.

In one or more embodiments, 3G-SGSN 150 can assume responsibility for delivery of data packets from and to mobile stations within the 3G-SGSN's geographical service or coverage area. The 3G-SGSN 150 can perform functions including packet routing and transfer, mobility management (e.g., attach/detach and location management), logical link management, and/or authentication and charging functions. In one or more embodiments, a location register of the 3G-SGSN 150 can store location information (e.g., current cell) and user profiles (e.g., addresses used in the packet data network) of users registered with the 3G-SGSN 150.

In one or more embodiments, a Home Subscriber Server (HSS) 155 can be provided that is a central database that contains user-related and subscription-related information. The functions of the HSS 155 include functionalities such as mobility management, call and session establishment support, user authentication and access authorization. In one embodiment, the HSS 155 can manage subscription-related information in real time, for multi-access and multi-domain offerings in an all-IP environment. The HSS 155 can be based on Home Location Register (HLR) and Authentication Center (AuC).

In one or more embodiments, MME 160 can perform the function of a control-node. For example, the MME 160 can perform functions such as idle mode tracking and paging procedure including retransmissions. The MME 160 can also choose a serving gateway for the end user device 110 such as at the initial attach and at time of intra-LTE handover involving node relocation. MME 160 and HHS 155 can be accessed when the end-user device 110 attempts to re-register to user E-UTRAN 120 to access the core network 105.

In one or more embodiments, a Serving Gateway (S-GW) 170 can route and forward user data packets, while also acting as the mobility anchor for the user plane during inter-eNodeB handovers and as the anchor for mobility between LTE and other 3GPP technologies (e.g., terminating S4 interface and relaying the traffic between 2G/3G systems and P-GW 175). For idle state UEs 110, the S-GW 170 can terminate the downlink data path and can trigger paging when downlink data arrives for the UE 110. The S-GW 170 can manage and can store UE 110 contexts, e.g. parameters of the IP bearer service, network internal routing information.

In one or more embodiments, a PDN Gateway (P-GW) 175 can provide connectivity from the UE 110 to external packet data networks by being the point of exit and entry of traffic for the UE 110. UE 110 can have simultaneous connectivity with more than one P-GW 175 for accessing multiple PDNs. The P-GW 175 can perform policy enforcement, packet filtering for each user, charging support, lawful interception and/or packet screening. The P-GW 175 can also act as the anchor for mobility between 3GPP and non-3GPP technologies such as WiMAX and 3GPP2 (CDMA 1X and EvDO).

In one or more embodiments, a Policy Control Resource Function (PCRF) 180 can be provided. For example, the PCRF 180 can be a software node designated in real-time to determine policy rules. As a policy tool, the PCRF 180 can operate at the network core and can access subscriber databases and other specialized functions, such as a charging system, in a centralized manner. The PCRF 180 can aggregate information to and from the network, operational support systems, and other sources (such as portals) in real time, supporting the creation of rules and then automatically making policy decisions for each subscriber active on the network. The PCRF 180 can provide a network agnostic solution (e.g., wire line and/or wireless) and can be integrated with different platforms like billing, rating, charging, and subscriber database or can also be deployed as a standalone entity. The functions performed by the PCRF 180 can be any variety of functions, such as computer implemented steps in a process or algorithm associated with operation of a mobile communications network.

In one or more embodiments, system 100 can provide for circuit switching as a fallback for packet switching so as to enable the provisioning of voice and other circuit switching-domain services (e.g., circuit switching UDI video/LCS/USSD) by reuse of circuit switching infrastructure, whenever the packet switching-domain services are down or overloaded. For example, an end-user device 110 can be served by E-UTRAN 120 connecting to Evolved Node B 140 for accessing packet-switched services. At some point, E-UTRAN 120 can become unavailable or can experience impaired availability due overloading and/or required maintenance. In response to the unavailability, E-UTRAN 120 can disconnect from the end-user device 110. As a fallback response, the end-user device 110 can respond by establishing a connection with UMTS 130 or can activate a prior connection with UMTS 130. The end-user device 110 can access the core functions 105 of the service provider network via UMTS 130 and 3G-SGSN 150. In one or more embodiments, a circuit-switching fallback enabled terminal (e.g., UE 110) connected to E-UTRAN 140 may use UMTS 130 to connect to the circuit switching-domain in fallback mode. In one or more embodiments, the circuit switching fallback and the Internet Protocol Multimedia Subsystem (IMS) based services of system 100 can co-exist in a single service operator's network 185.

In one or more embodiments, the system 100 can provide a time period to the end user device 110. The end user device 110 can use the time period as a delay. For example, when the end user device 110 detects that it has been logged off from E-UTRAN 120, then the end user device 110 can immediately fall back to using UMTS 130 as the wireless connection to the core network 105. The end user device 110 can also set an internal timer, which can be implemented as hardware, software, or a combination of hardware and software. The timer can be set with the value of the time period so that the time period can be counted out until it expires.

In one or more embodiments, the system 100 can combine the expiration of the time period with a request by the user device 110 for data services to create a unique delay for the end user device 110. For example, after the end-user device 110 falls back from E-UTRAN 120 to UMTS 130, then the end-user device 110 can wait for the time period to expire. The end-user device 110 can then wait for a request for data services by, for example, monitoring a user interface. In one embodiment, the end-user device 110 can monitor for activation of any application that could require data services, such as an internet site, a search application, and/or a media application. If data services are not requested by the end-user device 110, then the device should remain at the UMTS 130 for at least two reasons. First, UMTS 130 will be sufficient to satisfy the non-data needs, such as voice telephony and/or texting. Second, by remaining with UMTS 130, the end-user device 110 is delaying the time for requesting reentry to E-UTRAN 120 until the end-user device 110 truly needs highest speed data services. In this way, a random delay for re-registration with E-UTRAN 120 is built in. The random delay is made up of the time period (received from the system 100) plus a variable time for the end-user device 110 to demand data services after the time period expires. By configuring all end-user devices 110 fallback coupled to the secondary UMTS 130 to wait to return to E-UTRAN 120 in this way, the system 100 can ensure that the return of devices is smoothed out by relative randomness of requests to return to E-UTRAN 120 caused by the randomly variable delays.

In one embodiment, the time delay can be downloaded onto the end-user device 110 from the system. For example, the time delay can be downloaded during initializing of the end-user device 110, such as during startup of the device and/or during registration of the device with E-UTRAN 120 and/or the core network 105. In one embodiment, the time delay can be downloaded periodically. In one embodiment, the system 100 and/or E-UTRAN 120 can adjust the time delay to account for changes in conditions at the network and/or at E-UTRAN 120. For example, as loading increases or decreases and/or in anticipation of downtimes, the time period can be adjusted upward or downward.

In one embodiment, the time period can be a random number and/or can be constructed by combining a constant number with a random number. For example, for any given end-user device 110 that has fallen back from E-UTRAN 120, the time period can be set to a constant number, such as five seconds, plus a random number of additional seconds. In the case where the end-user device 110 delays attempting to re-register with E-UTRAN 120 until the expiration of the time period PLUS a request for data services, the addition of the random number to the delay serves to guarantee a first level of randomness (provided by the random number) in the return sequence. Additional randomness is then introduced by the behavior/choices of a user of the device 11. If the end-user device 110 is configured to immediately attempt reentry after the time period, without further requiring a request for data services, then the addition of the random number component to the time period can provide adequate randomness to protect the system 100.

In one embodiment, each end-user device 110 can receive a unique, or potentially unique, time delay from the system 100. In one embodiment, each of the end-user devices 110 can be assigned time periods. The time periods can be based on factors such as a subscription service level of the device 110, where a higher level of service can, for example, merit shorter delays, of zero delays, in returning to E-UTRAN 120. Conversely, lower contracted service levels can result in longer delays in rebounding from the fall back. In another embodiment, the random number component of the time delay can be generated at the end-user device 110. For example, a random number generator, at the end-user device 110, can generate the random component of the time delay. In another embodiment, the time delay can be generated for the end-user device 110 based on a configuration at the device 110. For example, if the user has configured the end-user device to disable the data service for the device 110, then the time delay can be extended to reflect the using status of the device 110.

In one or more embodiments, after the expiration of the time delay, plus an additional delay while waiting for the end-user device 110 to request data services from the network 100, the end-use device can request reentry to E-UTRAN 120 by attempting to register with the core network 105 through the E-UTRAN 120. The end-user device 110 can then wait for an indication that reentry has been granted. The end-user device 110 can function normally while waiting, including performing data and/or voice services over UMTS 130. In one embodiment, if re-registration is rejected, then end-user device 110 can delay for additional time, which can be the same randomized time, before attempting to retry.

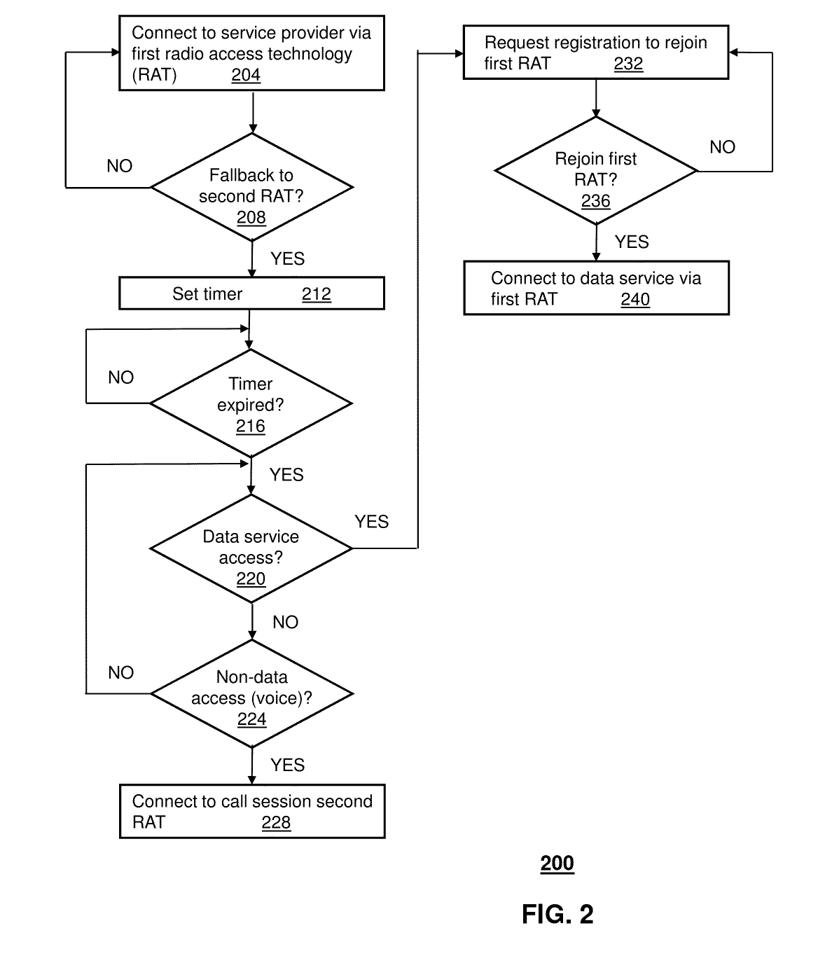

FIG. 2 depicts an illustrative embodiment of a method for reliably switching between a first radio access technology and a second radio access technology. Method 200 can begin at 202 with an end-user device 110 connecting to a service provider via a first radio access technology (RAT). For example, the end-user device 110 can connect to an LTE system 100 via E-UTRAN 120. The end-user device 110 can access core functions 105 to transmit and/or receive packet-switched data via the LTE system using a highest speed wireless front-end.

In step 208, the end-user device 110 can determine if the system 100 has terminated the connection with E-UTRAN 120. For example, E-UTRAN 120 can become unavailable or can experience impaired availability due overloading and/or required maintenance. In response to the unavailability, E-UTRAN 120 can disconnect from the end-user device 110. As a fallback response, the end-user device 110 can respond by automatically establishing a connection with a second RAT, such as UMTS 130 or can activate a prior connection with UMTS 130. The end-user device 110 can access the core functions 105 of the service provider network via UMTS 130 and 3G-SGSN 150, while the primary RAT, E-UTRAN 120 is down or has otherwise terminated connection to the end-user device 110.

In step 212, the end-user device 110 set a time period for delaying requesting reentry to the first RAT. The end user device 110 can also set an internal timer, which can be implemented as hardware, software, or a combination of hardware and software. The timer can be set with the value of the time period so that the time period can be counted out until it expires. In one embodiment, the time delay can be downloaded onto the end-user device 110 from the system. In one embodiment, the system 100 and/or E-UTRAN 120 can adjust the time delay to account for changes in conditions at the network and/or at E-UTRAN 120 In one embodiment, the time period can be a random number and/or can be constructed by combining a constant number with a random number. In the case where the end-user device 110 delays attempting to re-register with E-UTRAN 120 until the expiration of the time period PLUS a request for data services, the addition of the random number to the delay serves to guarantee a first level of randomness.

In one embodiment, each end-user device 110 can receive a unique, or potentially unique, time delay from the system 100. The time periods can be based on factors such as a subscription service level of the device 110, where a higher level of service can, for example, merit shorter delays, of zero delays, in returning to E-UTRAN 120. In another embodiment, the random number component of the time delay can be generated at the end-user device 110.

In step 216, the end-user device 110 can determine if the timer as expired and, if so, can then determine, at step 220, if data service access has been requested. In one or more embodiments, the system 100 can combine the expiration of the time period with a request by the user device 110 for data services to create a unique delay for the end user device 110. For example, after the end-user device 110 falls back from E-UTRAN 120 to UMTS 130, then the end-user device 110 can wait for the time period to expire. The end-user device 110 can then wait for a request for data services. In one embodiment, the end-user device 110 can monitor for activation of any application that could require data services, such as an internet site, a search application, and/or a media application.

If data services are not requested by the end-user device 110, at step 220, then the device can remain at the UMTS 130, which will be sufficient to satisfy the non-data needs, such as voice telephony and/or texting while delaying the time for requesting reentry to E-UTRAN 120 until the end-user device 110 truly needs highest speed data services. At step 224, the end-user device 110 can determine if a non-data access has been requested. For example, the end-user device 110 can request a voice service due to an initiation of a call session in which the end-user device 110 is a participant. If, for example, a call session, such as voice or text, is requested for the end-user device 110, then the session is completed using the second RAT (UMTS 130) in step 228.

If a data service request is detected at step 220, after the timer has expired in step 216, then the end-user device 110 can attempt to reenter the first RAT (E-UTRAN 120) by requesting re-registration at step 232. In one embodiment, a random delay is created by the combination of the time period (which can include a random component) plus a random time for the end-user device 110 to demand data services after the time period expires. Additional randomness is introduced by the behavior/choices of a user of the device 110. However, if the end-user device 110 is configured to immediately attempt reentry after the time period, without further requiring a request for data services, then the addition of the random number component to the time period can provide adequate randomness to protect the system 100.

In step 236, the end-user device 110 can wait for an indication that reentry has been granted and, if granted, then the end-user device 110 can reconnect to the first RAT (E-UTRAN 120) in step 240.

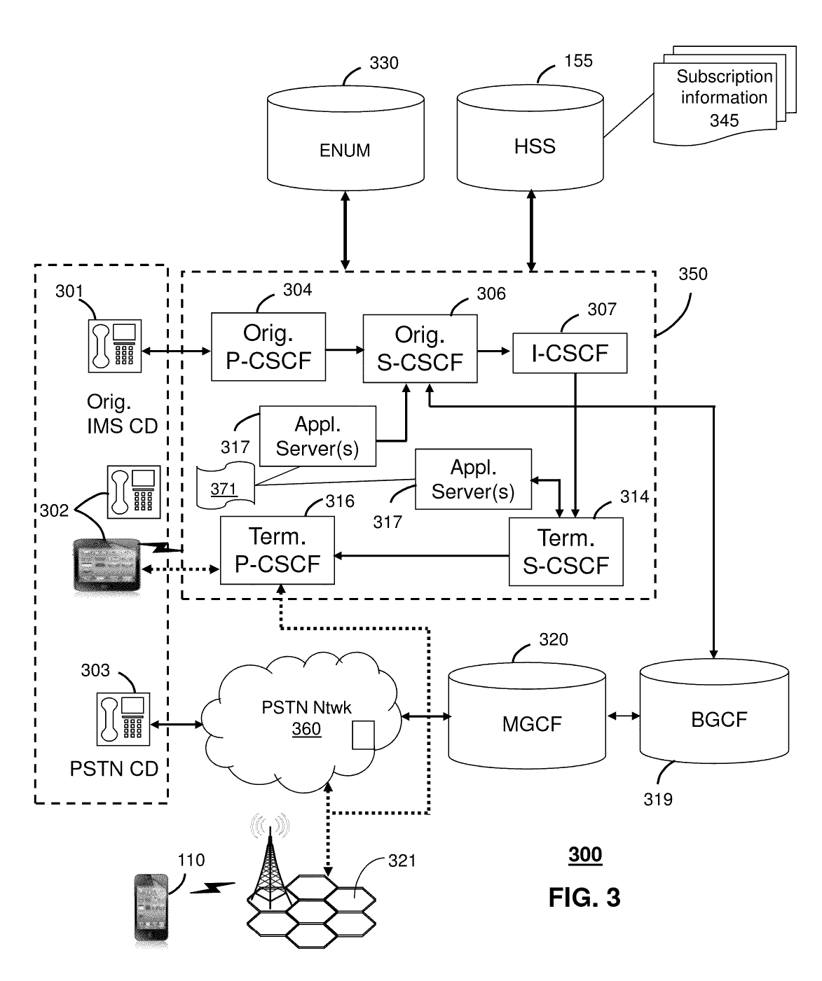

FIG. 3 depicts an illustrative embodiment of the cellular system for providing network access to a mobile device via alternative radio access technologies. Communication system 300 can be overlaid or operably coupled with systems 100 of FIG. 1 as another representative embodiment of communication system 100. System 300 can be used with method 200 for timing reentry of end-user devices 110 to a first RAT (E-UTRAN 120) after a fall back event. System 300 allows for setting a timer to a time period after sensing of a fallback event, where an end-user device 110 is switched from a first radio access technology to a second radio access technology. The system 300 facilitates detecting an expiration of the time period at timer and, in turn, enabling registration according to the detecting both the expiration of the time period and detecting a data service access request at a user interface. The system 300 enables sending a registration request to rejoin the first radio access technology according to the enabling of registration.

Communication system 300 can comprise a Home Subscriber Server (HSS) 340, a tElephone NUmber Mapping (ENUM) server 330, and other network elements of an IMS network 350. The HSS 155 can receive subscription information 345, such as from PCRF 180 of FIG. 1). The subscription information 345 can be stored and used for a session event reporting registration process for subscribing devices (e.g., application servers 317 selectively requesting ULI). In one embodiment, the HSS 155 can report ULI, such as by querying PCRF, which will report upon detection of session events identified in subscription information while not reporting other ULI for session events that are not identified in subscription events.

The IMS network 350 can establish communications between IMS-compliant communication devices (CDs) 301, 302, Public Switched Telephone Network (PSTN) CDs 303, 305, and combinations thereof by way of a Media Gateway Control Function (MGCF) 320 coupled to a PSTN network 360. The MGCF 320 need not be used when a communication session involves IMS CD to IMS CD communications. A communication session involving at least one PSTN CD may utilize the MGCF 320.

IMS CDs 301, 302 can register with the IMS network 350 by contacting a Proxy Call Session Control Function (P-CSCF) which communicates with an interrogating CSCF (I-CSCF), which in turn, communicates with a Serving CSCF (S-CSCF) to register the CDs with the HSS 155. To initiate a communication session between CDs, an originating IMS CD 301 can submit a Session Initiation Protocol (SIP INVITE) message to an originating P-CSCF 304 which communicates with a corresponding originating S-CSCF 306.

The originating S-CSCF 306 can submit the SIP INVITE message to one or more application servers 317 that can provide a variety of services to IMS subscribers. For example, the application servers 317 can be used for various functions including billing and/or network performance analysis. In one embodiment, the application servers 317 can be used to perform originating call feature treatment functions on the calling party number received by the originating S-CSCF 306 in the SIP INVITE message. Originating treatment functions can include determining whether the calling party number has international calling services, call ID blocking, calling name blocking, 7-digit dialing, and/or is requesting special telephony features (e.g., *72 forward calls, *73 cancel call forwarding, *67 for caller ID blocking, and so on). Based on initial filter criteria (iFCs) in a subscriber profile associated with a CD, one or more application servers may be invoked to provide various call originating feature services.

Additionally, the originating S-CSCF 306 can submit queries to the ENUM system 330 to translate an E.164 telephone number in the SIP INVITE message to a SIP Uniform Resource Identifier (URI) if the terminating communication device is IMS-compliant. The SIP URI can be used by an Interrogating CSCF (I-CSCF) 307 to submit a query to the HSS 340 to identify a terminating S-CSCF 314 associated with a terminating IMS CD such as reference 302. Once identified, the I-CSCF 307 can submit the SIP INVITE message to the terminating S-CSCF 314. The terminating S-CSCF 314 can then identify a terminating P-CSCF 316 associated with the terminating CD 302. The P-CSCF 316 may then signal the CD 302 to establish Voice over Internet Protocol (VoIP) communication services, thereby enabling the calling and called parties to engage in voice and/or data communications. Based on the iFCs in the subscriber profile, one or more application servers may be invoked to provide various call terminating feature services, such as call forwarding, do not disturb, music tones, simultaneous ringing, sequential ringing, etc.

In some instances the aforementioned communication process is symmetrical. Accordingly, the terms “originating” and “terminating” in FIG. 3 may be interchangeable. It is further noted that communication system 300 can be adapted to support video conferencing. In addition, communication system 300 can be adapted to provide the IMS CDs 301, 302 with multimedia and Internet services.

If the terminating communication device is instead a PSTN CD such as CD 303 or CD 305 (in instances where the cellular phone only supports circuit-switched voice communications), the ENUM system 330 can respond with an unsuccessful address resolution which can cause the originating S-CSCF 306 to forward the call to the MGCF 320 via a Breakout Gateway Control Function (BGCF) 319. The MGCF 320 can then initiate the call to the terminating PSTN CD over the PSTN network 360 to enable the calling and called parties to engage in voice and/or data communications.

It is further appreciated that the CDs of FIG. 3 can operate as wireline or wireless devices. For example, the CDs of FIG. 3 can be communicatively coupled to a cellular base station 321, a femtocell, a WiFi router, a Digital Enhanced Cordless Telecommunications (DECT) base unit, or another suitable wireless access unit to establish communications with the IMS network 350 of FIG. 3. The cellular access base station 321 can operate according to common wireless access protocols such as GSM, CDMA, TDMA, UMTS, WiMax, SDR, LTE, and so on. Other present and next generation wireless network technologies can be used by one or more embodiments of the subject disclosure. Accordingly, multiple wireline and wireless communication technologies can be used by the CDs of FIG. 3.

Cellular phones supporting LTE can support packet-switched voice and packet-switched data communications and thus may operate as IMS-compliant mobile devices. In this embodiment, the cellular base station 321 may communicate directly with the IMS network 350 as shown by the arrow connecting the cellular base station 321 and the P-CSCF 316.

Alternative forms of a CSCF can operate in a device, system, component, or other form of centralized or distributed hardware and/or software. Indeed, a respective CSCF may be embodied as a respective CSCF system having one or more computers or servers, either centralized or distributed, where each computer or server may be configured to perform or provide, in whole or in part, any method, step, or functionality described herein in accordance with a respective CSCF. Likewise, other functions, servers and computers described herein, including but not limited to, the HSS, the ENUM server, the BGCF, and the MGCF, can be embodied in a respective system having one or more computers or servers, either centralized or distributed, where each computer or server may be configured to perform or provide, in whole or in part, any method, step, or functionality described herein in accordance with a respective function, server, or computer.

Application servers 317 can be adapted to perform function 371 (e.g., via software executed at the application server) which can include subscribing to session events for selective reporting of ULI. As an example, the application server 317 can subscribe to the PCC (e.g., PCRF 180) which allows the application server 317 to selectively receive ULI based on events that are pertinent to the functions being performed by the application server without receiving unnecessary ULI for events that are not pertinent to the functions being performed by the AF. For instance, an application server 317 that is performing location-based service authorization can subscribe to session initiation events and session updates caused by user mobility while not subscribing to session terminations. In this example, the application server 317 can monitor the location of the UE based on the ULI to enforce authorization of location-based services in only a particular area. The subscribing function 371 performed by the application server 317 can result in distribution of the subscription information 345 to devices that are part of the ULI reporting process, such as HSS 155 or an MME (not shown).

For illustration purposes only, the terms S-CSCF, P-CSCF, I-CSCF, and so on, can be server devices, but may be referred to in the subject disclosure without the word “server.” It is also understood that any form of a CSCF server can operate in a device, system, component, or other form of centralized or distributed hardware and software. It is further noted that these terms and other terms such as DIAMETER commands are terms can include features, methodologies, and/or fields that may be described in whole or in part by standards bodies such as 3rd Generation Partnership Project (3GPP). It is further noted that some or all embodiments of the subject disclosure may in whole or in part modify, supplement, or otherwise supersede final or proposed standards published and promulgated by 3GPP.

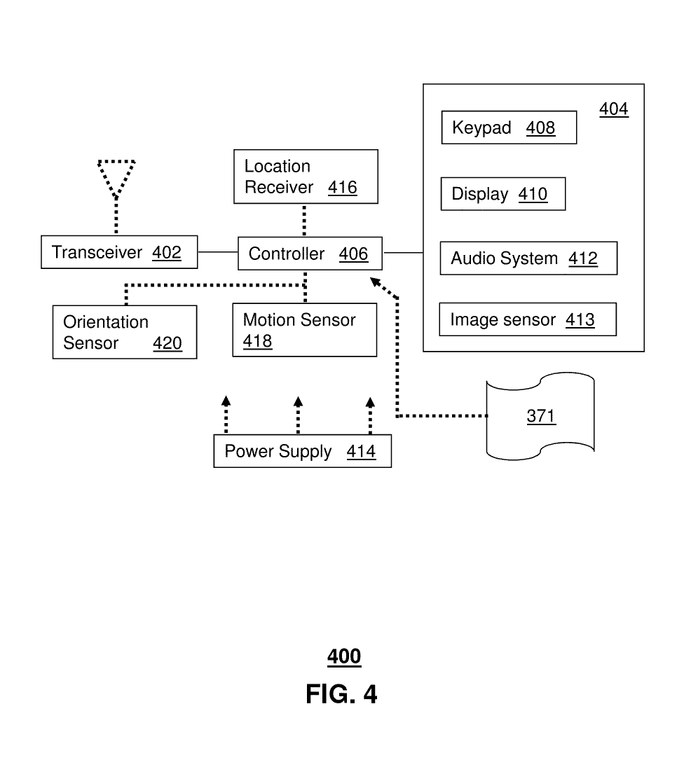

FIG. 4 depicts an illustrative embodiment of a communication device that can be used in achieving network access via alternative radio access technologies. Communication device 400 can serve in whole or in part as an illustrative embodiment of the devices depicted in FIGS. 1 and 3, including application servers, PCEF devices, PCRF devices, UEs, HSS, MME and so forth. Device 400 can be a server that performs policy control and charging functions in a mobile communications network. Device 400 can receive subscriptions from a subset of application servers of a plurality of application servers, where the subscriptions identify session events of a communication session for which the subset of application servers request user location information, or a subset of the triggering events are subscribed. Device 400 can provide subscription information based on the subscriptions to core network nodes of the mobile communications network. Device 400 can receive user location information from the core network nodes responsive to detection of triggering events corresponding to the session events of the subscriptions. Device 400 can provide the user location information to an IP multimedia subsystem network for delivery to the subset of application servers without delivery to remaining application servers of the plurality of application servers that did not subscribe to the session events, or without delivering the ULI for undesired subsequent triggering events.

To enable selective reporting of ULI via a subscriber registration process, communication device 400 can comprise various components such as one or more of a wireline and/or wireless transceiver 402 (herein transceiver 402), a user interface (UI) 404, a power supply 414, a location receiver 416, a motion sensor 418, an orientation sensor 420, and a controller 406 for managing operations thereof. The transceiver 402 can support short-range or long-range wireless access technologies such as Bluetooth, ZigBee, WiFi, DECT, or cellular communication technologies, just to mention a few. Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 402 can also be adapted to support circuit-switched wireline access technologies (such as PSTN), packet-switched wireline access technologies (such as TCP/IP, VoIP, etc.), and combinations thereof.

The UI 404 can include a depressible or touch-sensitive keypad 408 with a navigation mechanism such as a roller ball, a joystick, a mouse, or a navigation disk for manipulating operations of the communication device 400. The keypad 408 can be an integral part of a housing assembly of the communication device 400 or an independent device operably coupled thereto by a tethered wireline interface (such as a USB cable) or a wireless interface supporting for example Bluetooth. The keypad 408 can represent a numeric keypad commonly used by phones, and/or a QWERTY keypad with alphanumeric keys. The UI 404 can further include a display 410 such as monochrome or color LCD (Liquid Crystal Display), OLED (Organic Light Emitting Diode) or other suitable display technology for conveying images to an end user of the communication device 400. In an embodiment where the display 410 is touch-sensitive, a portion or all of the keypad 408 can be presented by way of the display 410 with navigation features.

The display 410 can use touch screen technology to also serve as a user interface for detecting user input. As a touch screen display, the communication device 400 can be adapted to present a user interface with graphical user interface (GUI) elements that can be selected by a user with a touch of a finger. The touch screen display 410 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 410 can be an integral part of the housing assembly of the communication device 400 or an independent device communicatively coupled thereto by a tethered wireline interface (such as a cable) or a wireless interface.

The UI 404 can also include an audio system 412 that utilizes audio technology for conveying low volume audio (such as audio heard in proximity of a human ear) and high volume audio (such as speakerphone for hands free operation). The audio system 412 can further include a microphone for receiving audible signals of an end user. The audio system 412 can also be used for voice recognition applications. The UI 404 can further include an image sensor 413 such as a charged coupled device (CCD) camera for capturing still or moving images.

The power supply 414 can utilize common power management technologies such as replaceable and rechargeable batteries, supply regulation technologies, and/or charging system technologies for supplying energy to the components of the communication device 400 to facilitate long-range or short-range portable applications. Alternatively, or in combination, the charging system can utilize external power sources such as DC power supplied over a physical interface such as a USB port or other suitable tethering technologies.

The location receiver 416 can utilize location technology such as a global positioning system (GPS) receiver capable of assisted GPS for identifying a location of the communication device 400 based on signals generated by a constellation of GPS satellites, which can be used for facilitating location services such as navigation. The motion sensor 418 can utilize motion sensing technology such as an accelerometer, a gyroscope, or other suitable motion sensing technology to detect motion of the communication device 400 in three-dimensional space. The orientation sensor 420 can utilize orientation sensing technology such as a magnetometer to detect the orientation of the communication device 400 (north, south, west, and east, as well as combined orientations in degrees, minutes, or other suitable orientation metrics).

The communication device 400 can use the transceiver 402 to also determine a proximity to a cellular, WiFi, Bluetooth, or other wireless access points by sensing techniques such as utilizing a received signal strength indicator (RSSI) and/or signal time of arrival (TOA) or time of flight (TOF) measurements. The controller 406 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 400.

Other components not shown in FIG. 4 can be used in one or more embodiments of the subject disclosure. For instance, the communication device 400 can include a reset button (not shown). The reset button can be used to reset the controller 406 of the communication device 400. In yet another embodiment, the communication device 400 can also include a factory default setting button positioned, for example, below a small hole in a housing assembly of the communication device 400 to force the communication device 400 to re-establish factory settings. In this embodiment, a user can use a protruding object such as a pen or paper clip tip to reach into the hole and depress the default setting button. The communication device 400 can also include a slot for adding or removing an identity module such as a Subscriber Identity Module (SIM) card. SIM cards can be used for identifying subscriber services, executing programs, storing subscriber data, and so forth.

The communication device 400 as described herein can operate with more or less of the circuit components shown in FIG. 4. These variant embodiments can be used in one or more embodiments of the subject disclosure.

The communication device 400 shown in FIG. 4 or portions thereof can serve as a representation of one or more of the devices of systems 100 and/or 300 of FIGS. 1 and 3. In addition, the controller 406 can be adapted in various embodiments to perform the functions 371 to enable a subscriber registration process that distributes subscription information so that ULI is selectively reported based on particular detected session events that are pertinent to the functions of the subscribing device, such as ULI being reported for session termination events to an application server performing network performance analysis.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

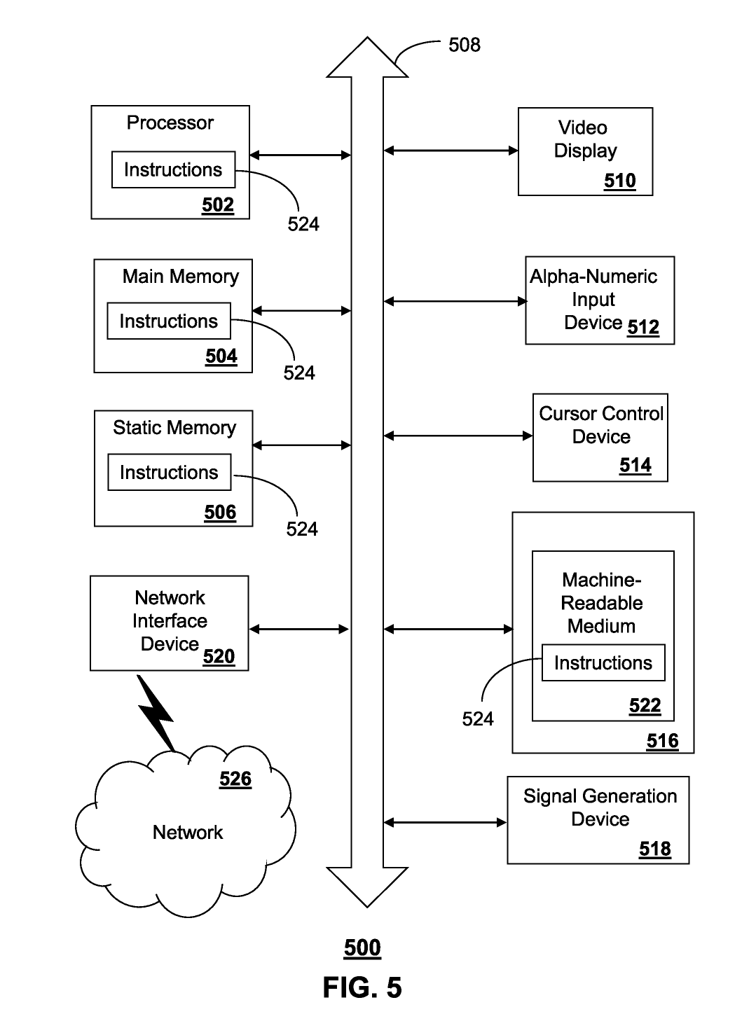

FIG. 5 depicts an exemplary diagrammatic representation of a machine in the form of a computer system 500 within which a set of instructions, when executed, may cause the machine to perform any one or more of the methods described above. One or more instances of the machine can operate, for example, as a PCC (e.g., the PCRF 180 and/or the PCEF 220), an MME, an HSS, an application server, a UE and other devices of FIGS. 1-2 and 5-6 to enable selective ULI reporting based on a subscription process. For example, the machine can receive a subscription from an application server, where the machine performs policy control and charging functions in a mobile communications network, and where the subscription identifies a session event occurring in a communication session for which the application server requests user location information. The machine can provide subscription information based on the subscription to core network nodes of the mobile communications network. The machine can receive user location information from the core network nodes responsive to a detection of a triggering event corresponding to the session event of the subscription. The machine can provide the user location information to an IP multimedia subsystem network for delivery to the application server, where the delivery of the user location information is limited to application servers that are subscribed to the session event, and/or only for the event/sub-event an application server has subscribed.

In some embodiments, the machine may be connected (e.g., using a network 526) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 500 may include a processor (or controller) 502 (e.g., a central processing unit (CPU), a graphics processing unit (GPU, or both), a main memory 504 and a static memory 506, which communicate with each other via a bus 508. The computer system 500 may further include a display unit 510 (e.g., a liquid crystal display (LCD), a flat panel, or a solid state display. The computer system 500 may include an input device 512 (e.g., a keyboard), a cursor control device 514 (e.g., a mouse), a disk drive unit 516, a signal generation device 518 (e.g., a speaker or remote control) and a network interface device 520. In distributed environments, the embodiments described in the subject disclosure can be adapted to utilize multiple display units 510 controlled by two or more computer systems 500. In this configuration, presentations described by the subject disclosure may in part be shown in a first of the display units 510, while the remaining portion is presented in a second of the display units 510.

The disk drive unit 516 may include a tangible computer-readable storage medium 522 on which is stored one or more sets of instructions (e.g., software 524) embodying any one or more of the methods or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute tangible computer-readable storage media.

Dedicated hardware implementations including, but not limited to, application specific integrated circuits, programmable logic arrays and other hardware devices that can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 522 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth, WiFi, Zigbee), and long-range communications (e.g., WiMAX, GSM, CDMA, LTE) can be used by computer system 500.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The exemplary embodiments described herein can be part of various communication systems including an Internet Protocol Television (IPTV) media system satellite and/or terrestrial communication systems. These systems can provide various services including voice video and/or data services. Multiple forms of media services can be offered to media devices (e.g., mobile communication devices, set top boxes, desk top computers, and so forth) over landline technologies. Additionally, media services can be offered to media devices by way of wireless technologies such as through use of a wireless access base station operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A mobile communication device comprising:
a processor; and
a memory that stores executable instructions that, when executed by the processor, facilitate performance of operations, comprising:
sensing a fallback event, wherein a service provider network terminates a first connection with the mobile communication device using a first radio access technology and wherein the service provider network initiates a second connection with the mobile communication device using a second radio access technology for routing of network communication with the mobile communication device;
setting a timer to a variable time period responsive to the sensing of the fallback event, wherein the setting of the timer is performed without consideration of a prior registration request to join the first radio access technology;
detecting an expiration of the variable time period at the timer;
detecting an input at a user interface, wherein the detecting of the input is subsequent to the detecting of the expiration of the variable time period;
determining whether the input comprises a data service access request;
sending a registration request to rejoin the first radio access technology responsive to the detecting of the data service access request; and
sensing a return event according to the registration request, wherein a third connection with the mobile communication device using the first radio access technology is initiated for the routing of the network communication with the mobile communication device.

2. The mobile communication device of claim 1, wherein the variable time period comprises a sum of a constant time period and a random time period.

3. The mobile communication device of claim 2, wherein the processor further performs operations comprising receiving the random time period from the service provider network.

4. The mobile communication device of claim 2, wherein the processor further performs operations comprising generating the random time period.

5. The mobile communication device of claim 1, wherein the processor further performs operations comprising receiving the variable time period from the service provider network, wherein the variable time period varies according to an operating condition associated with the first radio access technology.

6. The mobile communication device of claim 1, wherein the variable time period for the mobile communication device differs from a plurality of time periods at a plurality of mobile communication devices of the service provider network.

7. The mobile communication device of claim 1, wherein the variable time period varies according to a configuration associated with the mobile communication device.

8. The mobile communication device of claim 1, wherein the variable time period varies according to a subscription service level associated with the mobile communication device.

9. The mobile communication device of claim 1, wherein the first radio access technology supports packet-switched data services between the mobile communication device and the service provider network and wherein the second radio access technology supports circuit-switched data services between the mobile communication device and the service provider network.

10. The mobile communication device of claim 1, wherein the processor further performs operations comprising:
determining whether the input comprises a voice service access request;
sending the voice service access request to the service provider network via the second radio access technology; and
accessing the voice service via the second radio access technology.

11. The mobile communication device of claim 1, wherein the first radio access technology supports packet-switched data services between the mobile communication device and server provide network, wherein the second radio access technology supports circuit-switched data services between the mobile communication device and the service provider, wherein the processor further performs operations comprising receiving the variable time period from the service provider network, wherein the variable time period varies according to an operating condition associated with the first radio access technology.

12. The mobile communication device of claim 1, wherein the processor further performs operations comprising receiving the variable time period from the service provider via the second radio access technology, wherein the variable time period is updated by the service provider in response to a change in conditions at the first radio access technology.

13. The mobile communication device of claim 1, wherein the fallback event is triggered by overloading of the first radio access technology.

14. A non-transitory machine-readable storage medium, comprising executable instructions that, when executed by a processor, facilitate performance of operations, comprising:
sensing a fallback event, wherein a service provider network terminates a first connection with a mobile communication device using a first radio access technology and wherein the service provider network initiates a second connection with the mobile communication device using a second radio access technology for routing of network communication with the mobile communication device;
setting a timer to a time period responsive to the sensing of the fallback event, wherein the setting of the timer is performed without consideration of a prior registration request to join the first radio access technology;
detecting an expiration of the time period at the timer;
detecting a data service access request at a user interface subsequent to the detecting of the expiration of the time period;
enabling registration according to detecting both the expiration of the time period and the data service access request;
sending a registration request to rejoin the first radio access technology according to the enabling of the registration; and
sensing a return event according to the registration request, wherein a third connection with the mobile communication device using the first radio access technology is initiated for the routing of the network communication with the mobile communication device.

15. The non-transitory machine-readable storage medium of claim 14, wherein the time period comprises a sum of a constant time period and a variable time period, wherein the first radio access technology supports packet-switched data services between a mobile communication device and the service provider network and wherein the second radio access technology supports circuit-switched data services between the mobile communication device and the service provider network.

16. The non-transitory machine-readable storage medium of claim 14, wherein the executable instructions facilitate performance of operations, comprising:
detecting a voice service access request at the user interface; and
sending the voice service access request to the service provider network via the second radio access technology; and
accessing the voice service via the second radio access technology.

17. The non-transitory machine-readable storage medium of claim 14, wherein the time period is configured according to a subscription service level.

18. The non-transitory machine-readable storage medium of claim 14, wherein the executable instructions further cause the processor to perform operations comprising receiving the time period from the service provider network.

19. A method, comprising:
setting, at a system comprising a processor, a timer to a time period according to sensing of a fallback event, wherein a service provider network terminates a first connection with the system using a first radio access technology, wherein the service provider network initiates a second connection with the system using a second radio access technology for routing of network communication with the system, and wherein the setting of the timer is performed without consideration of a prior registration request to join the first radio access technology;
detecting, by the system, an expiration of the time period at timer;
enabling, by the system, registration according to the detecting both the expiration of the 1 time period and detecting a data service access request at a user interface of the system; and
sending, by the system, a registration request to rejoin the first radio access technology according to the enabling of registration.

20. The method of claim 19, wherein the first radio access technology supports packet-switched data services between a mobile communication device and the service provider network and wherein the second radio access technology supports circuit-switched data services between the mobile communication device and the service provider network.
